(19) United States
(12) Patent Application Publication
(10) Pub. No.: US 2016/0267401 A1
(43) Pub. Date: Sep. 15, 2016

(54) Event organizer method, system and graphical user interface with integrated participant list, menu tablet, and loyalty program

(71) Applicant: Zhong Zhi Huang, Toronto (CA)

(72) Inventor: Zhong Zhi Huang, Toronto (CA)

(73) Assignee: ZHONG ZHI HUANG, Toronto (CA)

(21) Appl. No.: 15/043,790

(22) Filed: Feb. 15, 2016

Related U.S. Application Data
(60) Provisional application No. 62/132,119, filed on Mar. 12, 2015.

(51) Int. Cl. G06Q 10/02; G06Q 30/02; G06Q 50/12; H04L 29/06; G06Q 10/10

(52) U.S. Cl. CPC G06Q 10/02; H04L 63/083; G06Q 10/1095; G06Q 50/12; G06Q 30/0226

(57) ABSTRACT

The present invention is an event or social gathering organizer, in the form of a web application. The event entries comprise of the event name, location, time, convener, telephone number and email address with a list for listing participants. An email address and telephone number can be entered with the owner's name. Upon processing of an event, the event organizer will send an email to each participant with links to accept/decline the event. By clicking the accept link, the participant can choose his/her preferences, and configure options related to the event. A dining organizer is an embodiment of this kind of event organizer, which lists a restaurant as the gathering place. In the present invention's system, each participant can pick drinks/dishes up beforehand anytime anywhere. It offers service providers a hardened customized function reduced menu tablet and also a tiers/segments based loyalty program.

### CROSS-REFERENCE

This application claims the benefit of U.S. Provisional Application No. 62/132,119, filed on Mar. 12, 2015, which application is incorporated herein by reference.

### FIELD OF INVENTION

The invention relates generally to a set of social gathering or event organizing aids. More particularly, the invention relates to the field of computer-implemented group dining together organizer applications. The invention will provide each participant a link which leads to a web application for managing the event activities. The application includes an integrated participant list. A hardened menu tablet and a loyalty program are also offered. The objective of the present invention is to allow users to organize and schedule events at venues easily.

### BACKGROUND OF THE INVENTION

Present day, there are numerous web sites with the function of allowing users to make restaurant reservations and organize other events. However, oftentimes such web sites and their constituent web applications only provide reservation service, and do not provide other functionalities.

Commonly, when users gather together for a meal, making a reservation is only the first step. Accordingly, there are other services which can enhance customer experience. Furthermore there are services which would be useful not just to restaurant customers, but also to restaurant staff. Both sides of the restaurant industry are considered to be the target audience of the present invention. It is therefore an objective of the present invention to introduce a system which provides such expanded services.

### SUMMARY OF THE INVENTION

The present invention is an event or social gathering organizer, in the form of a software application with hardware interaction. The event entry fields comprises of the event name, location, time, convener, telephone number and email address with a form for listing participants. An email address and telephone number can be entered with the owner's name. The user can choose a date for the event from a calendar.

Upon processing of an event, the event organizer supplied with a list for entering participants, will send each participant an email which contains two links: one to accept the event, another to decline with optional comments. While being redirected to the web application by clinking the accept link, the participant can choose his/her preferences, and configure options related to the event after login or register. Or, when the decline link is clicked, the decline action is recorded with optional comments.

A dining organizer is an embodiment of this kind of event organizer, which lists a restaurant as a gathering place. In the present invention's system, each participant can pick his/her drinks/dishes up by clicking the accept link in the email sent to her/him.

This event organizer has user options available. It may be configured to set event organizing permissions for every participant, or allow only the event convener to select individual preferences and activities picked for each participant.

It offers service providers a hardened customized function reduced menu tablet and also a tiering/segments based loyalty program.

### BRIEF DESCRIPTION OF THE DRAWING

FIG. 1 illustrates an exemplary event organizer system according to one embodiment;

FIG. 2 illustrates several components of an exemplary application server;

FIG. 3 illustrates several components of an exemplary client device;

FIG. 4 illustrates an exemplary dining event organizer—set up event & list participants;

FIG. 5 illustrates an exemplary dining organizer—in action—checking/selecting dishes/drinks;

FIG. 6 illustrates an exemplary dining organizer—in action—participant;

FIG. 7 illustrates an exemplary dining organizer/reservation—start point—login;

FIG. 8 illustrates an exemplary dining organizer/reservation—start point—not login;

FIG. 9 illustrates an exemplary event organizer page;

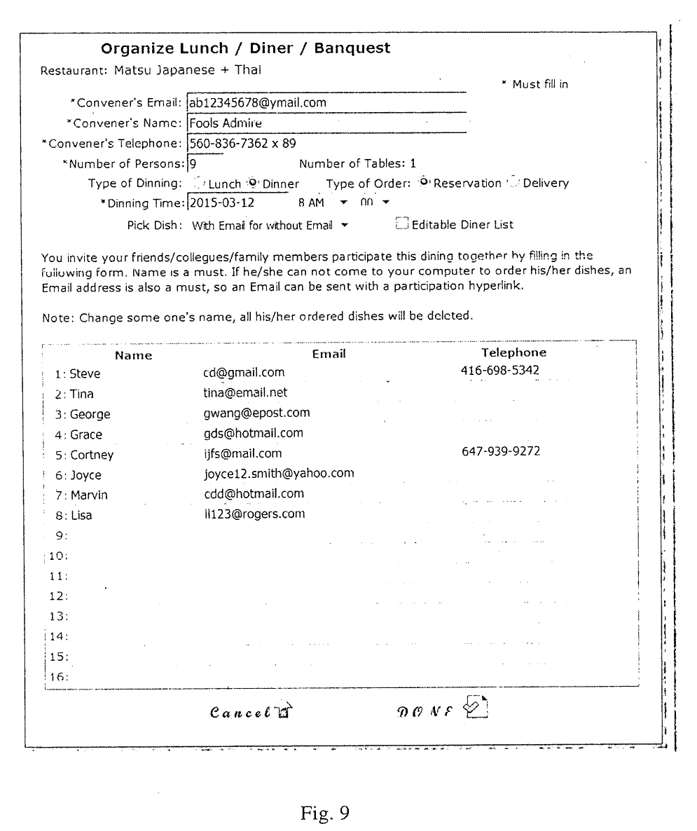

FIG. 10 illustrates an exemplary event organizer in action—highlight a participant;

FIG. 11 illustrates a dishes picker example—change and delete;

FIG. 12 illustrates a dishes picker example—highlight another participant;

FIG. 13 illustrates an exemplary dining organizer flow chart;

FIG. 14 illustrates an alert bracelet is sent when user orders it;

FIG. 15 illustrates the boot screen: Admin page of Menu tablet;

FIG. 16 illustrates Get Table page of Menu Tablet—No Reservation;

FIG. 17 illustrates Main Menu page of Menu Tablet;

FIG. 18 illustrates Dish Pick page of Menu Tablet;

FIG. 19 illustrates dish description window of Menu Tablet;

FIG. 20 illustrates Menu Tablet flow chart;

FIG. 21 illustrates loyalty program setup and measure scope;

FIG. 22 illustrates loyalty program measure scope;

FIG. 23 illustrates interactions and relationships of the major components;

FIG. 24 illustrates pipeline of usage;

FIG. 25 illustrates relationships between diner organizer's constituent subcomponents/sub-processes;

FIG. 26 illustrates relationships between menu tablet's constituent subcomponents/sub-processes;

FIG. 27 illustrates relationships between loyalty program's constituent subcomponents/sub-processes.

### DETAILED DESCRIPTION OF THE INVENTION

All illustrations of the drawings are for the purpose of describing selected versions of the present invention and are not intended to limit the scope of the present invention. Notably, software solutions may be implemented in a variety of ways while still fulfilling the same functionality.

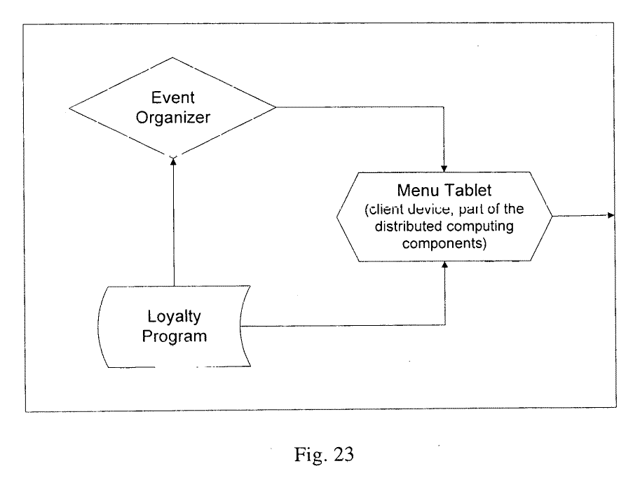

The present invention comprises of: a set of distributed computing components, an event organizer, a menu tablet, and a loyalty program. This is illustrated in FIG. 23. Some of these components/processes may be comprised of other subcomponents/sub-processes which will be discussed in detail later.

The first major component/process of the present invention is the set of distributed computing components. The set of distributed computing components are comprised of an application server, a client device, and minor industry-standard subcomponents.

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Notably, within this disclosure the phrases “in one embodiment,” “in various embodiments,” “in some embodiments,” and the like are used repeatedly. Such phrases do not necessarily refer to the same embodiment. The terms “comprising,” “consisting,” “having,” and “including” are synonymous, unless the context dictates otherwise.

Reference is now made in detail to the description of the embodiment as illustrated in the drawings. While the preferred embodiment is described in connection with the drawings and related descriptions, there is no intent to limit the scope of the invention to the embodiment disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

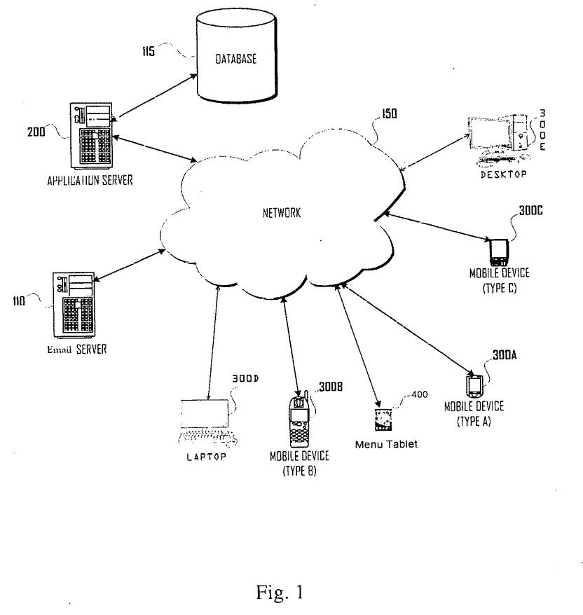

FIG. 1 illustrates an exemplary application using an event organizer system 100 according to one embodiment in which client including mobile devices 300A-C, laptop 300D, desktop 300E computers and 400 menu tablets.

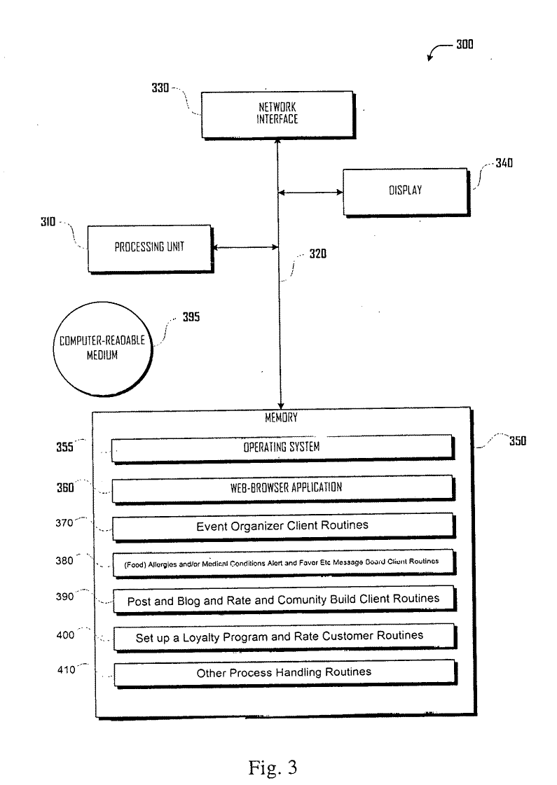

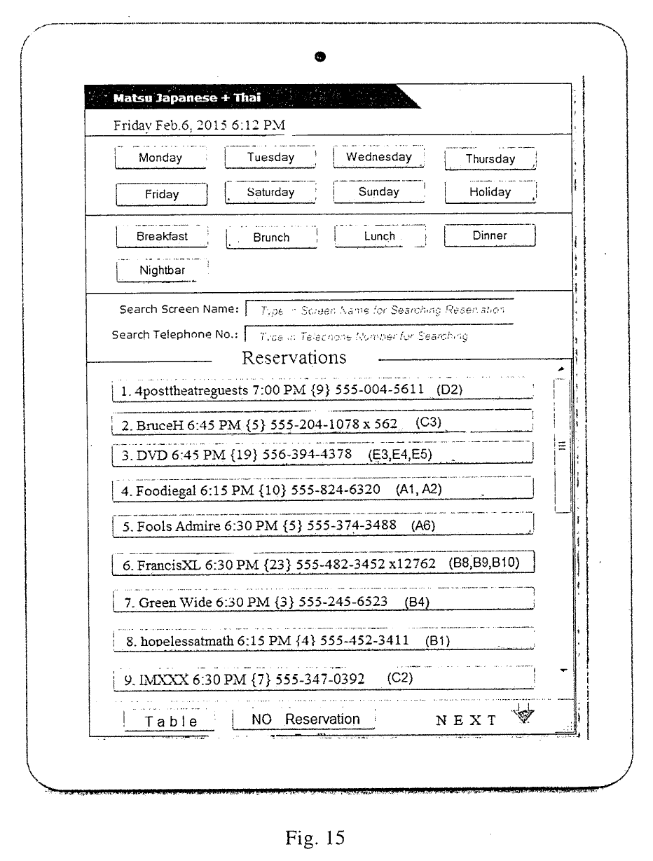

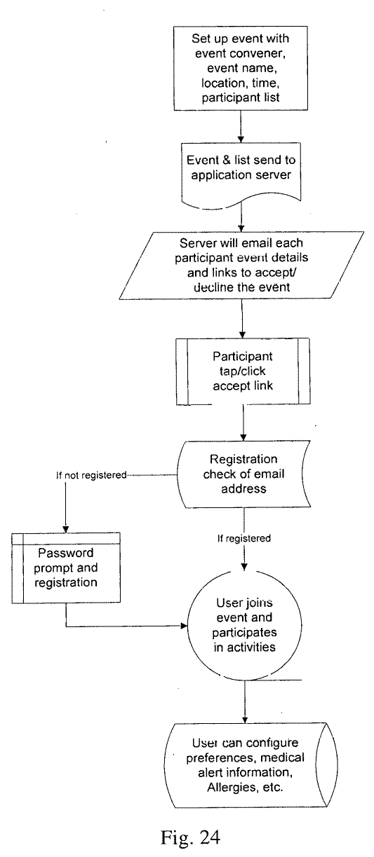

Please refer to FIG. 3 and FIG. 24 for the client components and processes. Also, in regards to the Menu Tablet, please see FIG. 15, 16, 17, 18, 19, 20.

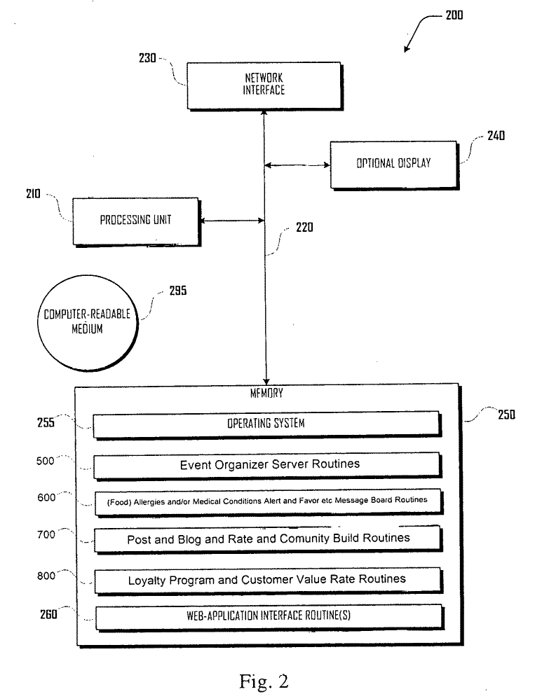

For the application server 200, see FIG. 2; the application server is connected to a network 150. In some embodiments, an Email server 110 is also connected to network 150, and application server 200 is in communication with database server 115, which may also be connected to network 150 in some embodiments. In some embodiments, Email server 110 may also be in direct communication with application server 200. In other embodiments, application server 200 and Email server 110 and database server 115 may comprise a single device.

In some embodiments, other servers and/or devices not shown may also be present. For example, in some embodiments, one or more proxy devices, firewalls, and/or other intermediaries not shown may exist between application server 200 and some or all of clients' 300A-E and menu tablet 400.

In some embodiments, application server 200 may communicate with database 115 via network 150, a storage area network (“SAN”), a high speed serial bus, and/or via other suitable communication technology. In some embodiments, application server 200, Email server 110, and/or database 115 may comprise one or more replicated and/or distributed physical or logical devices.

In various embodiments, network 150 may include the Internet, a local area network (“LAN”), a wide area network (“WAN”), a cellular data network, and/or other data network. In many embodiments, there may be more client devices 300 than are illustrated.

The first major subcomponent/sub-process of the set of distributed computing components is the application server.

FIG. 2 illustrates several components of an exemplary application server 200. In some embodiments, application server 200 may include many more components than those shown in FIG. 2. However, it is not necessary that all of these generally conventional components be shown in order to disclose an illustrative embodiment. As shown in FIG. 2, application server 200 includes a network interface 230 for connecting to the network 150.

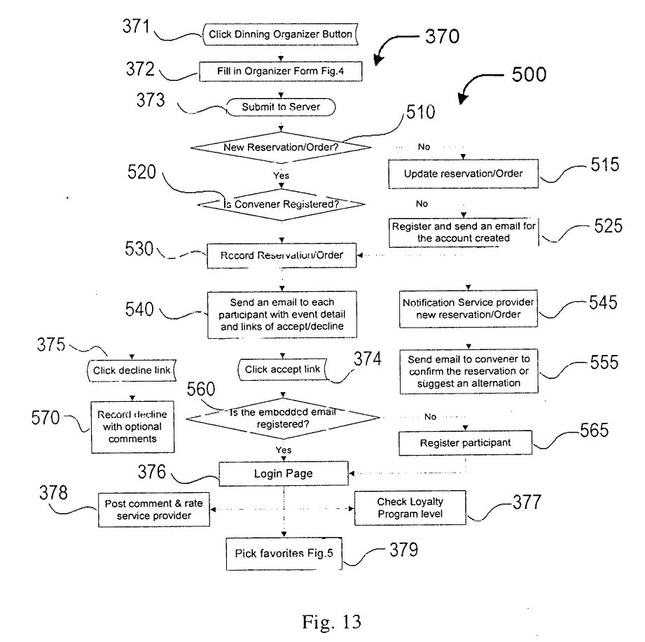

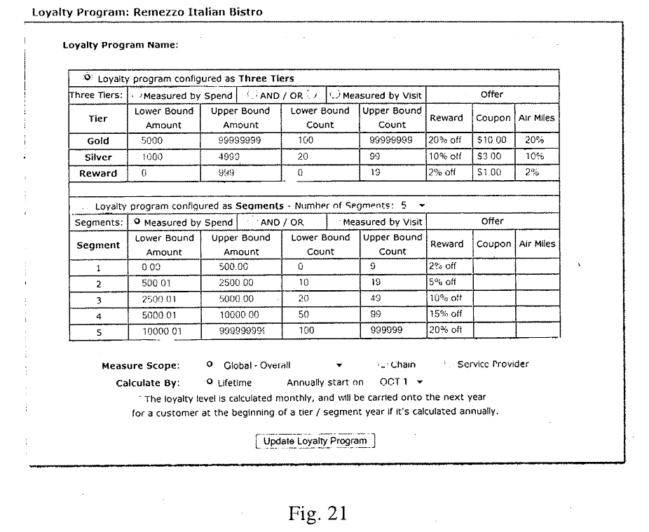

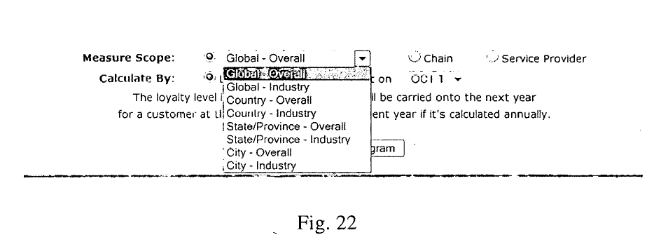

The application server 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for an event organizer routine 500. See FIG. 13, discussed below. Alert message routines 600 and the loyalty program component 800 are illustrated in FIG. 21 and FIG. 22, discussed below. These figures also illustrate community build component 700 and one or more web-application interface routines 260. In addition, the memory 250 also stores an operating system 255. These software components may be loaded from a computer readable storage medium 295 into memory 250 of the application server 200 using a drive mechanism, which is not shown, associated with a non-transient computer readable storage medium 295, such as a hard drive, floppy disc, tape, DVD/CD-ROM drive, memory card, or the like. In some embodiments, software components may also be loaded via the network interface 230, rather than via a computer readable storage medium 295.

In some embodiments, application server 200 may further comprise a specialized interface, not shown, for communicating with database 115, such as a high speed serial bus, or the like. In some embodiments, application server 200 may communicate with database 115 via network interface 230. In alternative or future embodiments, database 115 may reside in memory 250.

Although an exemplary application server 200 has been described that generally conforms to conventional general purpose computing devices, an application server 200 may be any of a great number of devices capable of communicating with the network 150, database 115, and/or clients 300A-E, menu tablet, for example, a personal computer, a game console, a set-top box, a handheld computer, a cell phone, or any other suitable devices.

The second major subcomponent/sub-process of the set of distributed computing components is the client device. FIG. 3 illustrates several components of an exemplary client device 300. In some embodiments, client device 300 may include many more components than those shown in FIG. 3. However, it is not necessary that all of these generally conventional components be shown in order to disclose an illustrative embodiment. As shown in FIG. 3, client device 300 includes a network interface 330 for connecting to the network 150.

Herein follows a description of the key constituent subcomponents of the client device. These individual subcomponents will not be described individually in detail because they are industry-standard. The client device 300 also includes a processing unit 310, a memory 350, and a display 340, all interconnected along with the network interface 330 via a bus 320. The memory 350 generally comprises a random access memory (“RAM”), a read only memory (“ROM”), and a permanent mass storage device, such as a hard drive, flash memory, or other persistent storage technology. The memory 350 stores program code for a web-browser application 360, as well as one or more event organizer routines 370, as illustrated in FIG. 13, discussed below. The memory also stores the allergy and medical alert message routine 380 and post, blog and rate etc., community build routines 390 and set up a loyalty program routine 400, and other routines for respectively handling event organizer, web access operations, e.g., a web browser and routines for invoking the web browser, and non-web-browser handling operations, e.g., one or more non-web-browser applications and routines for invoking the non-web-browser applications. In addition, the memory 350 also stores an operating system 355. These software components may be loaded from a computer readable storage medium 395 into memory 350 of the client device 300 using a drive mechanism, not shown, associated with a non-transient computer readable storage medium 395, such as a hard drive, floppy disc, tape, DVD/CD-ROM drive, memory card, or the like. In some embodiments, software components may also be loaded via the network interface 330, rather than via a computer readable storage medium 395.

Although an exemplary client device 300 has been described that generally conforms to conventional general purpose computing devices, an client device 300 may be any of a great number of devices capable of communicating with the network 150 and/or application server 200, for example, a personal computer, a game console, a set-top box, a handheld computer, a cell phone, or any other suitable device.

The next major component/process of the present invention is the event organizer, more specifically, the dining organizer, as an embodiment.

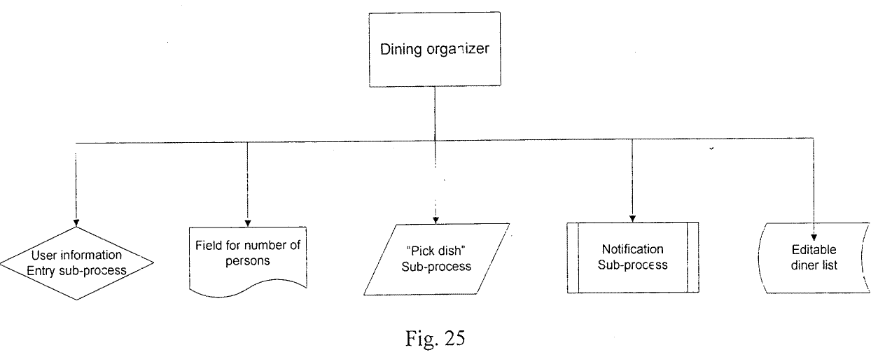

The dining organizer itself is comprised of a user information entry sub-process, a field for number of persons, a “pick dish” sub-process, a notification sub-process, and an editable diner list. This is illustrated in FIG. 25.

The first major subcomponent/sub-process of the dining organizer is the user information entry sub-process.

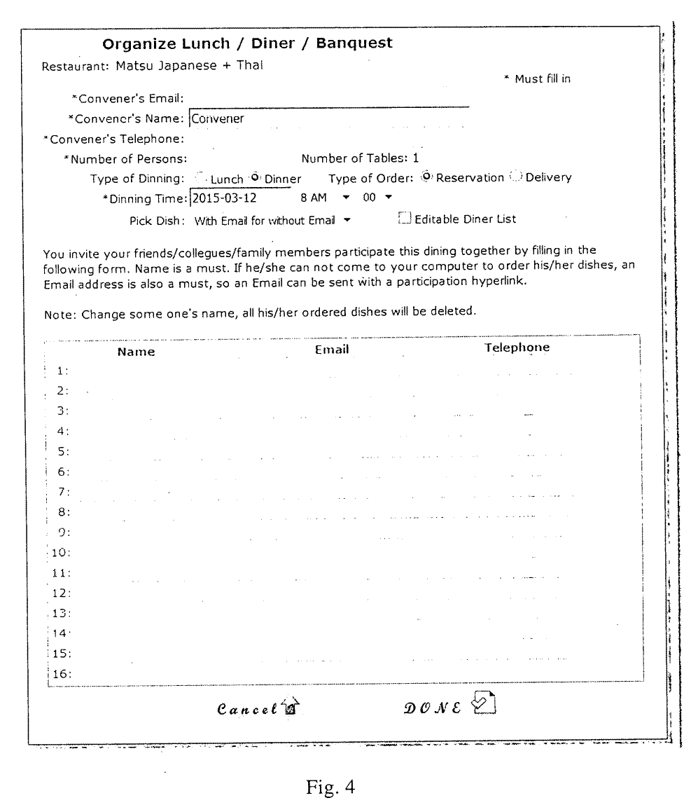

Reservation is only a part of dining organizer which is laid out as illustrated in FIG. 4. Most items are self-evidence in this event organizer. For example, the user needs to fill out his/her Email address in the field of “Convener's Email.” Here user is referred as event convener.

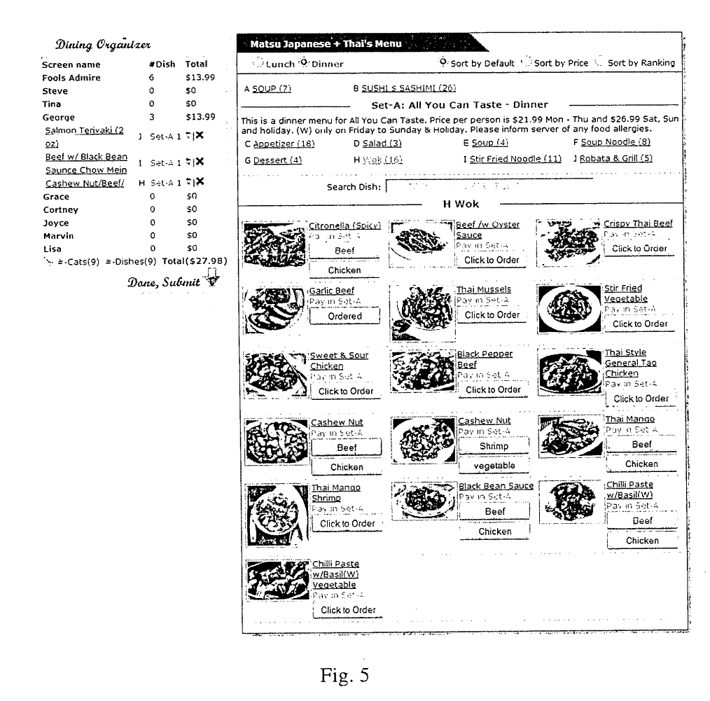

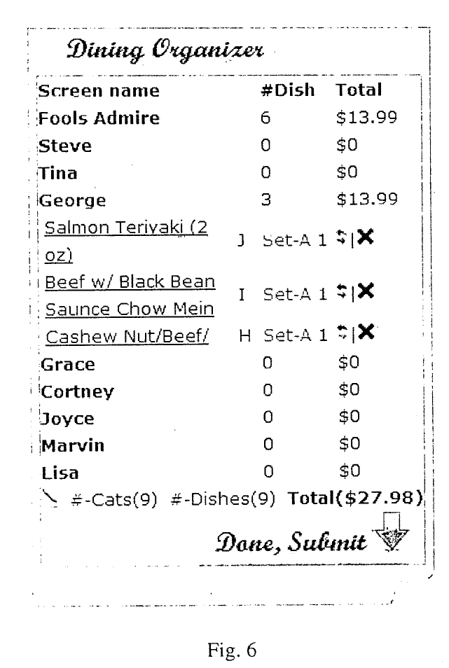

When the form is processed, it will send an email to each event participant with two links: one for accepting the event and choosing his/her preferences, activities, and/or options related to the event; another for declining with optional comments. When the accepting link is clicked, the server will check whether the participant is registered or not through the email address embedded in the link. If not, the server will request the user to enter a password, repeat the prompt to confirm the password, and register the participant. He/she can then join the event and participate the activities, such as, pick up his/her drinks and/or dishes, and so on. This is illustrated in FIG. 5 and FIG. 6. When the declining link is clicked, he/she is redirected to a page to confirm the declining action with a text field for entering comments.

As an event convener, he/she must register and log in or has to provide his/her name, an Email address and a telephone number for the service provider's confirmation.

The next major subcomponent/sub-process of the dining organizer is a field for number of persons. This field is used for dynamically changing the number of rows on the participant list. When the user types in a number greater than 16 into this field, the number of rows in the participant list will be increased accordingly.

The next major subcomponent/sub-process of the dining organizer is the “pick dish” sub-process. This sub-process itself comprised of four sub-processes. The combination of responses for these four choices is used to assign permissions for who can pick dishes for participants.

The first choice stipulates that anybody can pick for anybody, without restrictions.

The second choice stipulates that a single user will act as a convener. The convener can pick drinks/dishes for other participants. The other participants can only pick for themselves.

The third choice stipulates that only participants with submitted emails can pick dishes for those without email. Furthermore, no one can pick dishes for those with email. Those with email need to pick for themselves.

The fourth choice pertains to a convener for those without an email address. In this case, only the convener can pick dishes for those without email, others can only pick for themselves.

The last major subcomponent/sub-process of the dining organizer is the editable diner list sub-process. This sub-process comprises of a checkbox and the actual diner list.

The first sub-process of this editable diner list sub-process is a checkbox. This checkbox determines who can edit the list of participating diners. It is itself comprised of two options: only the convener or any login participant.

The second sub-process of this editable diner list sub-process is the actual diner list. If the checkbox is checked, this list can be edited by any participants. Any login participant can add a new participant or remove an existing participant in the list. Other edit operations are changing a participant's name, email address and telephone number. Again, if the checkbox is unchecked, it can only be edited by the convener. When a row of the participant list is focused while the user is logged in, the user's address book will be pop up for selecting. When an item is selected from the address book, the focused row will be filled with the selection; and direct typing in is also acceptable. A suggestion box will be keeping update along with you type in, so you can select from the suggestion box too. You can focus on name, or email, or telephone field and type in a name, an email address, or a telephone number, the suggestion box will display contacts for you to select based on name, email address or telephone number you are typing in. Notably, alternative or future embodiments of the invention may include additional options, or other input aids.

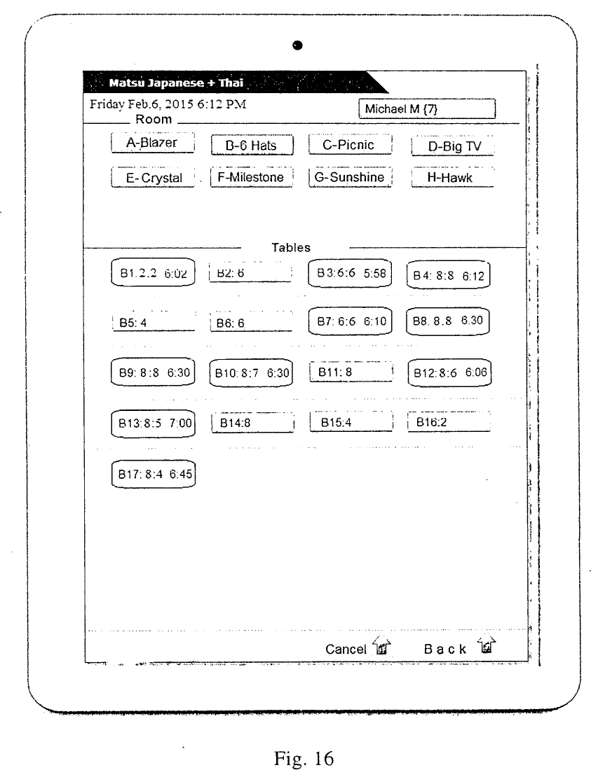

With this dining organizer, each user can check or pick drinks or dishes anywhere at any time with a computer or laptop or smart mobile device. The user does not have to wait to be in the restaurant to pick dishes/drinks. Notably, smart phones and other mobile devices may have different editions of these menus, closer to the menu tablet discussed in FIG. 15. Please also refer to FIGS. 16, 17, 18, and 19. The system will try to make determinations and render contents accordingly. Alternatively, users can explicitly select an edition of the menu. When the system determines that users connect from a mobile device with a calendar application installed, a button will be added to the event organizer for them to mark the event on their calendar.

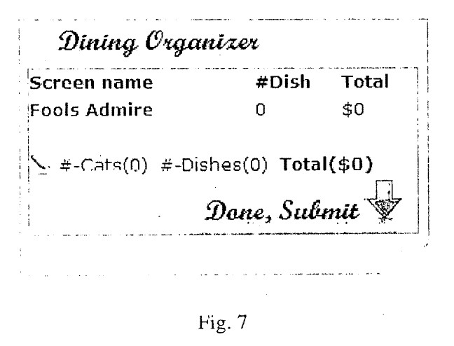

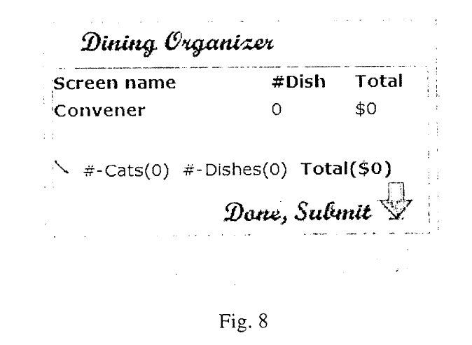

At the beginning, the user clicks the Dining Organizer button, as seen on FIG. 7 and FIG. 8 when he/she arrives at the Online Order page.

Herein follows a description of the possible process. The user enters him/herself as a dining convener and his/her invitees as illustrated in FIG. 4. If he/she has logged in, the convener's information will automatically be filled in according to his/her account. For each invitee, the convener will type in invitee's name, email address and/or telephone number; and then click the Done button. If the convener does not have an account, he/she does not need to login, instead, simply fills in these three fields. The server will then register him/her automatically and send an email with his/her account information. In this case, the convener's name, email address and telephone are required entry fields, as they are necessary for the confirmation and contact for any contingency.

The user does not have to list all participants or even any participant. It is acceptable if the user does not want to list them.

A reservation is in effect only when confirmed by the designated restaurant/service provider. If the convener has logged in while Dinning Organizer is clicked, the first three fields will be filled automatically according to the registration information on record.

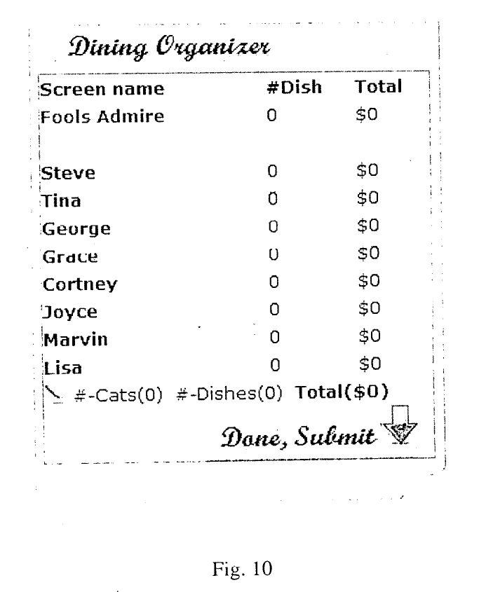

At this stage, the user is now ready to pick dishes/drinks as illustrated in FIG. 10 and FIG. 5. In screen FIG. 10, the user first highlight a participant, then start picking up dishes/drinks for the highlighted participant as illustrated in FIG. 5.

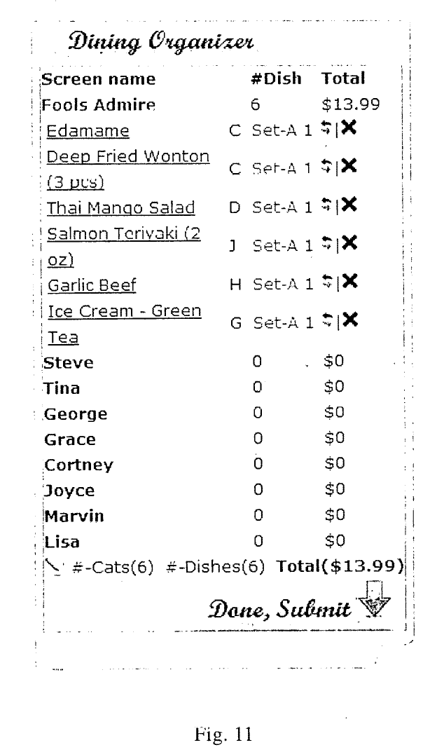

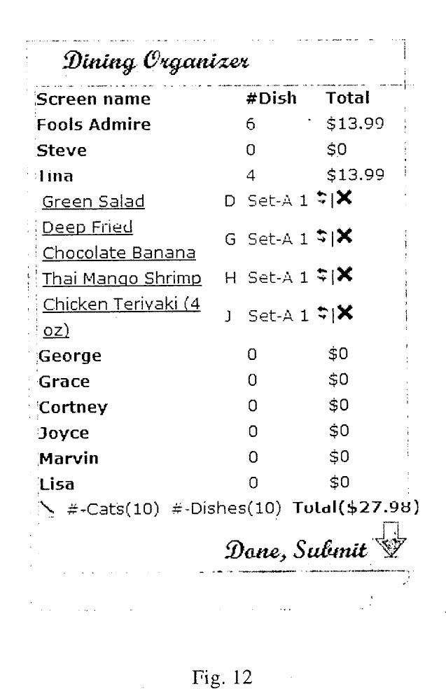

In the page illustrated in FIG. 11, the user can delete a dish by clicking the drop button or click change button to change the number of dishes. The actual icons used may vary between embodiments of the invention. Or even the buttons can be changed to others, such as increase + and decrease − buttons, not have to be drop and change buttons. If the user clicks on another participant to highlight her/him, her/his picks are expanded, as illustrated in FIG. 12. Alternative or future embodiments may use a different display scheme.

To reiterate, whether the user can select the dishes in this page for a person other than the login person depends on the “Pick Dish” setting determined by the convener.

When the user is done with picking dishes, the user clicks the “Done, Submit” button to submit his reservation and/or orders to the server and then to the restaurant. The reservation is valid until confirmed by the designated service provider.

Each dining participant with a valid email address will receive an email for the lunch/dinner/event with the restaurant name, address, telephone and time information, and s/he can pick her/his dishes or makes change to already pick only for his/her own orders by clicking the URL link embedded in the email.

FIG. 13 uses a dining out event as an embodiment of what an event organizer is. Notably, the present invention can be used for any social gathering event organizing. For example, in organizing a camp trip, the participants can pick what activities they want to engage: rock climb or tree top walk, etc. For organizing a cruise trip, the participants can choose which room they want to stay, select activities such as lagoon diving, chef table, and so on and on, depending on the service the provider operates. Thus, different service providers can have different activities for participants to choose. Component 379 is illustrated on FIG. 5 for the dining out event. The system can support different use cases and user interfaces design. Alternative and future embodiments may not be exactly as illustrated as FIG. 5. FIG. 5 is representative of only one of embodiment of activities participants can engage in. Even the event organizer for dining out above does not have to be implemented exactly as in the flow chart drawing. For example, if the application server registers a new user, it can directly lead him/her to picking his/her favorite drinks and/or dishes, instead of leading the user to the Login Page.

After a user registers with the system, he/she can optionally record his/her food allergies, medical conditions, or other information which requires the attention of the service providers. The information includes, but is not limited to: food or taste preferences, a reduced salt order, desired increase in spiciness/pepper/chili or other matters which require the attention of the service provider. This user-specific information is not viewable to the public and is only viewable by related service provider staff.

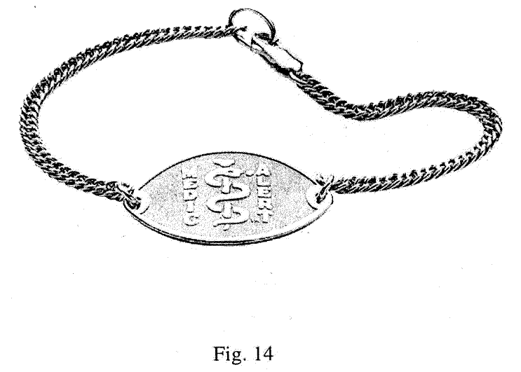

Notably, this information can include an order for a medical alert bracelet/necklace; this information can be sent to facilitate the alert service. The medical alert item can be any kind of device; it does not have to be the same as illustrated in FIG. 14. Alternative or future embodiments of the invention may support other forms of medical alert devices.

The next major component/process of the present invention is the menu tablet. The present invention offers service providers a function-reduced tablet for an activity/service menu, which is custom manufactured. This tablet will be designed to first load the service provider menu administration page when it is first turned on and automatically connects to the application server. This is illustrated in FIG. 15. The tablet has the ability to highlight the day and dining type, according to tablet calendar and clock. Notably, the staff always possesses the ability to change those options based on what the user desires.

The menu tablet supports the ability to display any image and media files. It downloads from the server only once, and caches the files locally until these files are changed again. It may simply copy these files directly to the tablet's non-volatile file system, which saves download network bands and speeds up operations.

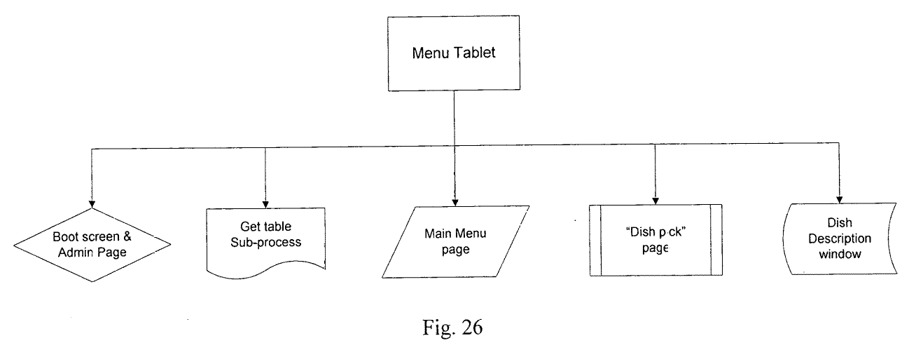

The menu tablet is itself comprised of a boot screen, an admin page, a get table sub-process, a main menu page, a dish pick page, a dish description window. This is illustrated in FIG. 26.

The first major subcomponent/sub-process of the menu tablet is the boot screen. This includes a login page and an administration page. The login page can be configured as a pattern lock or PIN or password, as the standard of a mobile device. The service provider is a restaurant in FIG. 15. The scenario illustrated is a customer arriving in its premise. If the customer has a reservation, staff will find the reservation. The scenario illustrated in FIG. 15 assumes the arriving customer has a screen name FrancisXL, with a reservation at 6:30 for 23 people, and the restaurant has allocated three tables for this group of diners. Usually, restaurant staff will hand over each person a tablet menu after clicking the NEXT button. The customer is not allowed to operate on this admin page. However, for a reservation group, there will not be one tablet issued for each person, just one for a table is sufficient.

For customers without a reservation, the user taps the “NO Reservation” button, a window is popped up asking for a name and a number of persons. It brings the user to the Get Table page after you enter a name and a number. This will let the user allocate tables for the no reservation customers. The user can change tables for those reservation customers by highlighting a reservation and tapping the “Table” button. FIG. 16 illustrates the Get Table page:

The next major subcomponent/sub-process of the menu tablet is the Get Table sub-process.

The Get Table page comprises of two parts: a room list and table list of the highlighted room. FIG. 16 shows the restaurant has eight rooms. Currently, the page illustrates the 6 Hats room, which has 17 tables. Those cannot be clicked, as they are occupied. For an occupied table, there are three numbers and a time, listed as follows: the table No., table capacity and the number of diners booked, showing how many persons can be seated at the table and will be seated, and the time occupied or reserved.

For those tables not occupied, only the first two are shown as table No. and table capacity, and rendered as a button. It asks for a number of persons and a time when an unallocated table button is tapped.

After highlighting a day, a service type, and a reservation, the user clicks the NEXT button of the admin page. The user is then taken to the main menu page of the menu tablet.

The next major subcomponent/sub-process of the menu tablet is the main menu page.

In the main menu page, the user can highlight a name, which will expand if the person has picked dishes/drinks. The user can edit those already picked dishes by tapping the two buttons: the change button, to change the number of dishes, or drop button, to remove a dish. These buttons do not have to be drop and change buttons. They can be increase + and decrease − buttons in other embodiments. And the icons used for these two buttons may vary too.

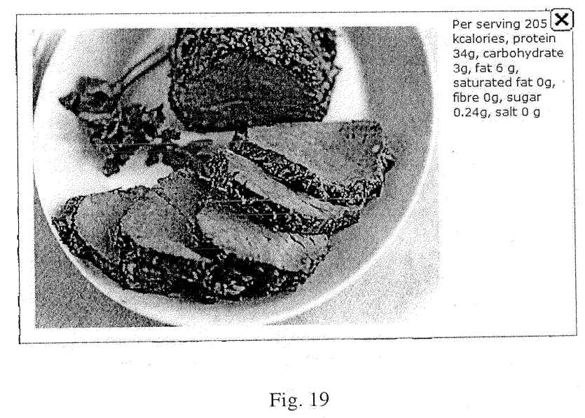

These dish names are tappable. When a user taps one, a dish description window will pop up. Please refer to FIG. 19 for an example implementation of the dish description window.

For customers without a reservation, in the Dining Organizer area, you can enter dinners by tapping Add Person button, then typing in a name, and optionally an email address and telephone number.

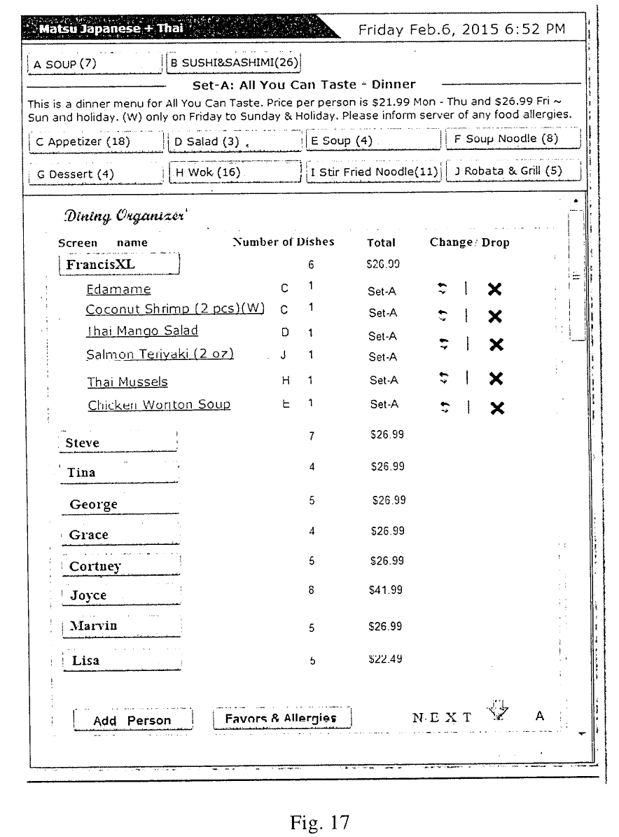

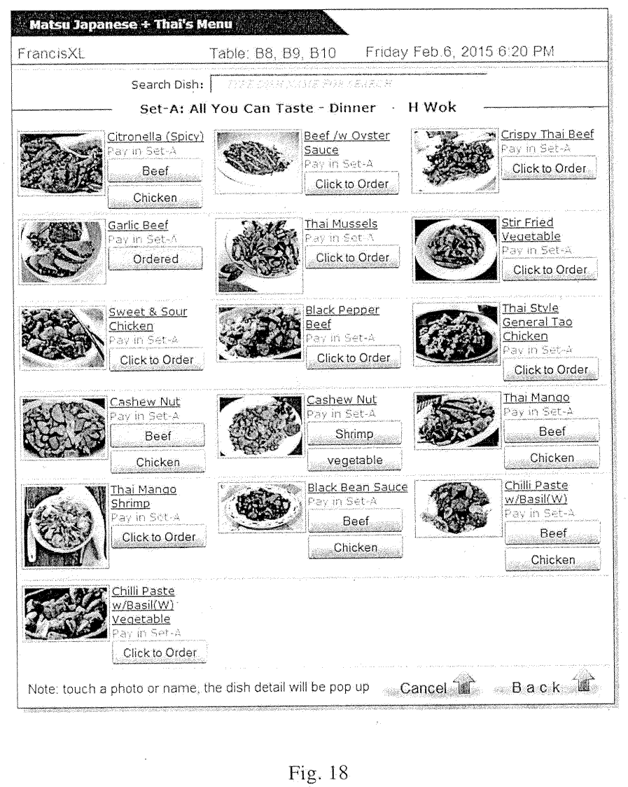

Then, the user highlights a menu category and a diner, such as in the FIG. 17. The menu item H Wok and diner FrancisXL are highlighted, and the user taps the NEXT button to get to the Dish Pick page. The user will then select dishes from the highlighted menu item. Notably, in the invention's preferred embodiment, at any moment, the user can highlight only one diner. When the user highlights one diner, the previously highlighted diner will be turned to normal automatically. FIG. 18 is the Dish Pick page of Menu Tablet.

Notably, a customer cannot access the admin page as illustrated in FIG. 15. In order for a staff member to return to the admin page, he/she taps the A button at the right bottom of the tablet, then the login page will be shown. When the login succeeds, the admin page is displayed; if fails, the user is returned to main menu page with a flash message states login fails. In alternative or future embodiments of the invention, a different lock implementation may be used and/or the user may be redirected to different screens.

The next major subcomponent/sub-process of the menu tablet is the dish pick page. This is illustrated in FIG. 18. In this Dish Pick page, the user taps a button to select a dish of which the button is tied to. The user can check each dish by tapping its icon picture or name. When the user taps an icon picture, a dish description window will be pop up. Notably, the three column dishes displayed of the said dish pick page is only one embodiment. It can be one or two or other numbers of columns of dish display, depends on the screen size of a mobile device. Furthermore, after a dish is selected, the button's color or content, or even the dish's content can be changed: such as when a dish is tapped once, digit 1, and two button of decrease − and increase + are displayed. When the increase button + is tapped, the digit 1 becomes 2; likewise, when the decrease button − is tapped, the digit is decreased 1. When it's decreased to zero, the digit is disappeared.

The last major subcomponent/sub-process of the menu tablet is the dish description window. A dish description window represents a dish with a picture and a text description. An implementation is illustrated in FIG. 19. The user taps the close button to return to the Dish Pick page or Main Menu page, depending on where it's triggered.

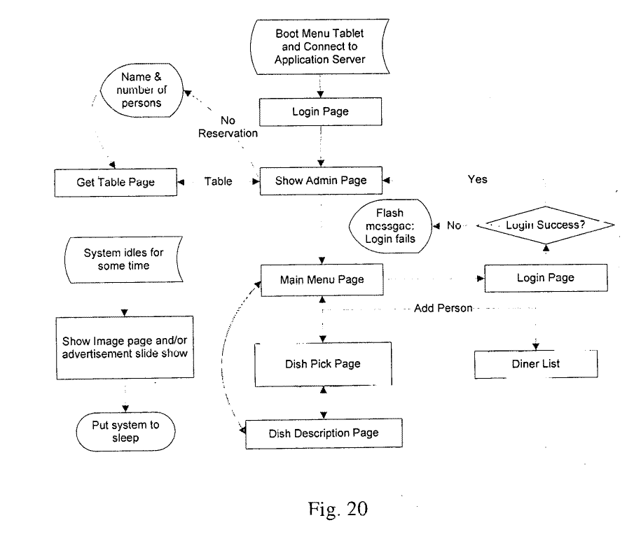

FIG. 20 illustrates the Menu Tablet flow chart. In the invention's preferred embodiment, this Menu Tablet logic is hardened onto ROM for a quick boot and energy saving. The tablet is custom manufactured by removing unnecessary components and functions to save energy and enable a longer running time.

When dining is concluded and every one is left, an email will be optionally sent to each diner with his/her individual receipt and other relevant info. Their loyalty program accounts will be updated accordingly if the restaurant has set up a loyalty program, which is described below.

Notably, to reiterate, the Menu Tablet is not only for restaurants, it can be customized for other industries. For example, the Menu Tablet can be used in the cruise trade. It can be used for tourists to pick a room, book a chef table and other activities and items the service provider offers. And the Menu Tablet can have other implementations, such as, the Main Menu page can be implemented as two pages: one only for the participant list and another only for the menu category.

The next major component/process of the present invention is the loyalty program. The event organizer includes a loyalty program with many configurable choices as seen in FIG. 21. The loyalty program can be either tiers or segments as defined later.

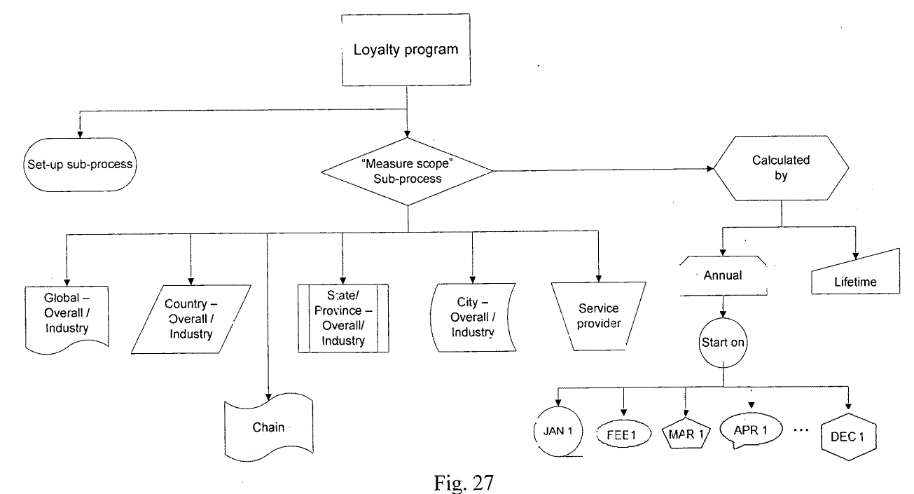

The loyalty program itself comprises of a set up sub-process, and a “measure scope” sub-process. This is illustrated in FIG. 27.

The first major subcomponent/sub-process of the loyalty program is the set up sub-process. Please refer to FIG. 21, in the invention's preferred embodiment, when the user arrives at the loyalty program configuration page, the field for the hosting organization's name will be displayed at the left top of the page. The user will enter a name for his/her loyalty program.

Then, the user decides whether the loyalty program is based on three tiers which is gold, silver and reward; or is configured as segments. Alternative or future embodiments may have fewer or additional tiers as an option.

If the loyalty program is determined to be based on three tiers, the user can configure how the three tiers are defined. They can be measured by spending amount, by visit count, or both, or either of the two. If both are chosen, the user would click the radio button prefix AND, which means both settings have to be met. If either is the choice, the user clicks the radio button after OR, which means either is met; the customer will get what's offered by the service provider. The user can select one of three types of the offers: reward, coupon or Air Miles. In alternative or future embodiments of the invention, other rewards are possible. The user usually offers one. He/she can choose to offer the mix of more than one, if so desired.

If the user configures the loyalty program with segments, s/he can design it as 5, or 6, up to 10 segments. Alternative or future embodiments of the invention may support other quantities of segments.

When the user chooses a number of segments, the rows below on the form will be automatically adjusted accordingly. The user can then define each segment. Same as the tiers, the user can configure it to be measured by spending amount, by visit count, both, or either of the two. Same as tiers, the user can configure rewards, based on these measurements.

The user can continue to define the space and time scope of his/her loyalty program, as per the ten choices of space scope illustrated in FIG. 22. This is discussed next.

The second major subcomponent/sub-process of the loyalty program is the “measure scope” sub-process, used for determining the extent of customer loyalty. There are multiple space measurements of loyalty, comprising of: global-overall, global-industry, country-overall, country-industry, state/province-overall, state/province-industry, city-overall, city-industry, chain, and service provide. These are defined as the following:

The first space measurement is Global-Overall. This means that any recorded spend or visit of a registered customer in the system to any service providers enrolled in the system, it's counted for the loyalty program;

The next measurement is Global-Industry. With Global-Industry, only the customer goes to the same industry as the service provider, his/her spending amounts and/or visit tally is counted. If the service provider is a restaurant, only customer goes to a restaurant, his/her spend/visit is added to the monthly calculation. Same if the service provider is hotel, only hotel spend/visit counts.

The next measurement is Country-Overall. Country-Overall means the customer spends in the country of the service provider, not global, but only in the service provider registered country. So the scope is smaller, others have the same meaning as the corresponding global one. Please note it's the service provider's registered country, not customer's registered country.

The same explanation applies to state/province, and city in a smaller scope.

Alternative or future embodiments of the invention may have different measurements of granularity for measuring loyalty than these described here. There may be fewer or more measurements according to the needs of the evolving industry.

Notably, you can define your loyalty program based on your chain if your organization belongs to a chain, or it is counted only if he/she spends/visits in your organization.

These loyalty measurements are calculated monthly. The accumulated amounts will be reset if it is based on an annual system. For a new year of a loyalty program, the system carries on the customer previous year tier/segment level. It lowers a customer's tier/segment level only at the end of a loyalty program year based on his/her entire year's spend/visit count, called as yearly process. A yearly time span can be defined as start on the first of a month of the twelve months of a year. So the yearly process is done after a defined year is completed. It increases a customer's tier/segment level on a monthly process supposing his/her measurement is met the corresponding criterion.

For the lifetime span, no reset will occur. Any spending/visit in the defined space scope is counted, and the loyalty level will not be lowered.

There is also a community build component of this event organizer. The customer can post comments and blog about service activities they experience, and rate the service. In turn, the service provider can rate the customer value. This data pertaining to customer ratings is not viewable to the public and is accessible only by service provider staff.

Although the invention has been explained in relation to its preferred embodiment, it is to be understood that many other possible modifications and variations can be made without departing from the spirit and scope of the invention. Obvious changes, modifications, and substitutions may be made by those skilled in the art to achieve the same purpose of the invention. The exemplary embodiments are merely examples and are not intended to limit the scope of the invention. It is intended that the present invention covers all other embodiments that are within the scope of the descriptions and their equivalents.

### PATENT CITATIONS

| PATENT CITATIONS | | | | |
|---|---|---|---|---|
| | Filing | Publication | | |
| Cited Patent | date | date | Applicant | Title |
| US20020019779 | Jun. 1, | Feb. 14, | Healey Timothy | Interactive order processing |
| | 2001 | 2002 | G. | system and method for global |
| | | | | computer network commerce |
| US20050209914 | Nov. 7, | Sep. 22, | Justin Nguyen, | System and method for |
| A1 | 2001 | 2005 | John Chang, | enterprise event marketing and |
| | | | etc. | management automation |
| US20110258125 | Apr. 16, | Oct. 20, | Vinay Rama Iyer | Collaborative Social Event |
| A1 | 2010 | 2011 | | Planning and Execution |
| US20140229390 | Feb. 12, | Aug. 14, | Stephen Abraham | Method and system for event |
| A1 | 2014 | 2014 | Morris, Bei Yang | planning |
| US7359946B2 | Jun. 23, | Apr. 15, | Atul Thakkar, | System and method for an event |
| | 2003 | 2008 | Esmail Sadeghi | planner |
| US8924490B2 | Jun. 30, | Dec. 30, | Chee Wee Tng | Service based event planning |
| | 2011 | 2014 | | |
| US20070233736 | Mar. 27, | Oct. 4, | Rebecca Xiong, | Method and system for social and |
| A1 | 2007 | 2007 | etc. | leisure life management |
| US20080294994 | May 16, | Nov. 27, | Justin David | Event management system and |
| A1 | 2008 | 2008 | Kruger, etc. | method with calendar interface |
| US20090265246 | Oct. 10, | Oct. 22, | Heather Nelson | System and method for |
| A1 | 2008 | 2009 | | connecting users based on event |
| | | | | planning and available venue |
| | | | | space |
| US20090307212 | Jul. 15, | Dec. 10, | Arik Ramot, etc. | System and method for event |
| A1 | 2007 | 2009 | | management |
| US20040158499 | Jul. 16, | Aug. 12, | Dev Roger H. | System and method for providing |
| | 2003 | 2004 | | self-service restaurant ordering |
| | | | | and payment |
| US20130246526 | Mar. 18, | Sep. 19, | Nam Wu, Travis | Consensus and preference event |
| A1 | 2012 | 2013 | Terwilligar | scheduling |
| US20130151637 | Dec. 13, | Jun. 13, | Anthony Bedikian | System and methods for filtering |
| A1 | 2011 | 2013 | | and organizing events and |
| | | | | activities |
| US20150326522 | May 4, | Nov. 12, | Ninghua Albert | System and methods for event- |
| A1 | 2015 | 2015 | Pu, etc. | defined and user controlled |
| | | | | interaction channel |
| US20150112738 | Oct. 20, | Apr. 23, | Douglas | Reserving venue for calendar |
| A1 | 2014 | 2015 | Marinaro, etc. | event |
| WO2014210162 | Jun. 25, | Dec. 31, | Farid SHIDFAR | System and method for on-line |
| A1 | 2014 | 2014 | | event promotion and group |
| | | | | planning |
| US20140172483 | Nov. 12, | Jun. 19, | Bart Bellers, etc. | Event management system |
| A1 | 2013 | 2014 | | |
| US20140101248 | Mar. 15, | Apr. 10, | Brian Felder, | Method, system and apparatus |
| A1 | 2013 | 2014 | David Shanley | for providing activity feed for |
| | | | | events to facilitate gathering and |
| | | | | communicating of event |
| | | | | information |
| US20100017714 | Jul. 16, | Jan. 21, | Anjili Agarwal, | Web based collaborative |
| A1 | 2008 | 2010 | Anil Agarwal | multimedia event planning, |
| | | | | hosting and deployment system |
| | | | | and web based personal |
| | | | | multimedia portable system |
| US20130346226 | Jun. 25, | Dec. 26, | Robert F. Nunes | Systems and methods for event |
| A1 | 2013 | 2013 | | planning and participation and a |
| | | | | ballot platform for transactions |
| | | | | for goods and services |
| US20050108097 | Nov. 19, | May 19, | Simpledine, Inc. | Web-based food ordering system |
| | 2004 | 2005 | | utilizing a text-to-speech engine |
| US8622292 | Sep. 29, | Jan. 7, | Jeffrey Bart Katz | Reservation-based |
| | 2005 | 2014 | | preauthorization payment system |
| US20070083400 | Sep. 29, | Apr. 12, | Katz Jeffrey B | Reservation-based |
| | 2005 | 2007 | | preauthorization payment system |
| US20060218043 | Jan. 24, | Sep. 28, | Michael | Computer-based method and |
| A1 | 2006 | 2006 | Rosenzweig, | system for online restaurant |
| | | | Homa G R, Becan | ordering |
| | | | Peter G | |
| US7818191 | Mar. 2, | Oct. 19, | Cfph, Llc | Receiving a request to reserve a |
| | 2007 | 2010 | | service |
| US8463649 | Mar. 2, | Jun. 11, | Cfph, Llc | Bidding for a request to reserve a |
| | 2007 | 2013 | | service |
| US8825529 | Mar. 2, | Sep. 2, | Cfph, Llc, | Submitting a request to reserve a |
| | 2007 | 2014 | | service |
| US20080215447 | Mar. 2, | Sep. 4, | Lutnick Howard | Bidding for a request to reserve a |
| | 2007 | 2008 | W | service |
| US20070276691 | May 14, | Nov. 29, | Ordercatcher, Llc | System and method for |
| | 2007 | 2007 | | processing orders from a menu |
| US20090089183 | Sep. 27, | Apr. 2, | Verizon | Multi-platform network for |
| | 2007 | 2009 | Laboratories Inc. | providing ordering services |
| US20110029335 | Oct. 18, | Feb. 3, | Lutnick Howard | Receiving a request to reserve a |
| | 2010 | 2011 | W | service |
| US20130144660 | Dec. 2, | Jun. 6, | Verizon Patent | Electronic maitre d' |
| | 2011 | 2013 | And Licensing Inc. | |
| US20120290413 | May. 9, | Nov. 15, | Restaurant | Systems and methods for take- |
| A1 | 2012 | 2012 | Revolution | out order management |
| | | | Technologies, Inc. | |
| US20130090959 | Oct. 8, | Apr. 11, | Seatme, Inc. | Restaurant management and |
| A1 | 2012 | 2013 | | reservation systems and methods |
| US20140101233 | Oct. 10, | Apr. 10, | Michael Mina | Recipe exchange and |
| | 2012 | 2014 | | management system |
| W02013088253 | Dec. 17, | Jun. 20, | Rejean Desrosiers | Map-based menu information |
| A2 | 2012 | 2013 | | network |
| US20140207589 | Jan. 21, | Jul. 24, | Toshiba Tec, | Order receiving apparatus and |
| | 2014 | 2014 | Kabushiki Kaisha | order receiving method |
| US20140343976 | May 7, | Nov. 20, | Nitesh Ahluwalia, | Computer-implemented systems |
| A1 | 2014 | 2014 | Alex Sayavong | and methods for restaurant |
| | | | | reservations and food orders |

| Non-Patent Citations | |
|---|---|
| Reference | |
| https://www.eventbrite.com/ | Event Management Online |
| http://www.opentable.com/ | Restaurants and Restaurant Reservations |
| http://www.torontorestaurants.com/ | Toronto Restaurants |
| https://www.seatme.yelp.com/ | Restaurant Reservation System And Software For |
| | Table Management |

1. A server-implemented method of event organizer applications, hosted on client devices including but not limited to: mobile-device types and/or laptop types and/or desktop types and/or menu tablet, the method comprising:
setup of an event with a user information entry, event name, location, time and a participant list, by the server, the user is referred as event convener;
the said event and the said list is sent to application server;
the server will email each participant the details of the event and two links to accept or decline the event;
when the accept link is clicked/tapped, the server checks the embedded email address to see whether it's registered;
the server will register the said email address by prompting the user to enter a password, then repeat the prompt to confirm the password, if the said email address is not registered;
the user joins the said event and participates in activities, this information is processed and recorded on the server;
the user attends the said event and participates in activities via the Menu Tablet, when the user and his/her party arrives at service provider's premise, this event is processed and recorded by the server;
the service provider may set up a loyalty program, which is processed and recorded on the server;
provide a community build service, by the server;
an email will be optionally sent to each participant with his/her individual receipt and other relevant info when the event has been concluded. His/her loyalty program account will be updated accordingly if the service provider has set up a loyalty program;
when the decline link is clicked/tapped, the action will be recorded with an optional comments for the convener checks;
the accepting or declining is not final; it can be changed up to some time before the event is occurred.

2. The method of claim 1, wherein providing the said event organizer for exposure to the said plurality of client devices, comprises:
a user information entry sub-process, by the server, as event convener, must register and login, or provide his/her screen name, an email address and a telephone number for the said service provider's confirmation. The information will also be needed as contingent contact;
a field for number of the said participants. Initially there are 16 rows in the participant list for listing participants. The said method automatically increases rows of the list accordingly when the number provided is greater than 16. The 16 initial rows can be another number depending on an embodiment. The number may not be exactly 16. To reiterate, the method can process and make changes to the row display according to this field. So when the number initially is 18 and when the number of participants is greater than 18, the method will increase the participant list to the said inputted number of rows;
a select field to define how a said participant picks his/her preferences/activities. There are four choices to assign permissions for who can pick preferences/activities for users. The choice of the said field does not have to be four. It can be greater or fewer in an implementation; also the field can be another kind of html field, it does not have to be a select field;
a checkbox field to define who can edit the said participant list: only the said event convener if uncheck; otherwise any logged in participant if checked. Other field type is feasible for serving the same requirement. Alternative or future embodiments of the invention may use the reverse, or include additional options.

3. The method of claim 2, wherein the said participant list comprising adjustable rows, where each row consists of three entry fields, one field each for participant's name, email address and telephone number. When a user is logged in and a row is focused, his/her address book will be pop up for selecting. When an item is selected from the address book, the row will be filled with the selection automatically. In addition, direct typing in is acceptable also. A suggestion box will be keeping update along with you type in, so you can select from the suggestion box too. You can focus on name, or email, or telephone field and type in a name, an email address, or a telephone number, the suggestion box will display contacts for you to choose based on name, email address or telephone number you are typing in. Notably, the configuration with three fields for each row is only one embodiment. There can be greater or fewer fields depending on business and/or design requirements; and alternative or future embodiments of the invention may include additional fields, or other input aids.

4. The method of claim 1, after registration and login, a said participant can optionally record his/her food allergies, medical conditions, and/or other information which requires the attention of the service providers. The information includes, but is not limited to: food or taste preferences, a reduced salt diet, a desired increase in spiciness/pepper/chili or other matters which require the attention of the service provider. This user-specific information is not viewable to the public but only viewable to related service provider staff. This information can include an order for a medical alert bracelet/necklace; this gadget can be sent to facilitate an alert service. The medical alert item can be any kind of device;
Alternative or future embodiments of the invention may support other forms of medical alert devices.

5. The method of claim 1, wherein said Menu Tablet is a function-reduced tablet for saving energy and enabling longer running time, which is custom manufactured. The said menu tablet comprising,
boot screen which includes a login page and an administration (abbr. admin) page. The login page can be configured as a pattern lock or PIN or password, as the standard of a mobile device. When a customer arrives and has a reservation, the said service provider's staff will find the reservation with which resources are allocated. For a customer without a reservation, the user taps the “NO Reservation” button and it brings the user to the Get Table page after answering a pop up window for a name and a number of persons;
admin page comprising of service provider's name, current date and time, day buttons and service type buttons, and a reservation list plus three button: Table, NO Reservation and NEXT. Optionally providing some search aids for finding a reservation;
get table page mainly comprises of two parts: a room list and table list of the highlighted room. When a table cannot be tapped, it is occupied. For an occupied table, there are three numbers and a time, listed as follows: the table no., table capacity and the number of diners booked, showing how many persons can be seated at the table and will be seated, and the time occupied or reserved. For those tables not occupied, only the first two are shown as table no. and table capacity, and rendered as a button;
if Table button is tapped while a reservation is highlighted, a user gets to the said get table page and can change tables for the reservation by tapping a table button to select/unselect it for the said reservation. When an unallocated table button is tapped, it becomes allocated after a number of persons and a time are provided. It displays the service provider's name and current date and time plus the name and number of the participants of the dinning/reservation on the top of the page;
after highlighting a day, a service type, and a reservation, the user clicks the NEXT button of the said admin page. The user is then redirected to the main menu page of the said menu tablet;
main menu page comprises of two components: the dishes/activities menu and participant list. The customer taps a participant name, which will expand if the person has picked dishes/drinks. The user can edit those picked dishes by tapping the two buttons: the change button, to change the number of dishes; and drop button, to remove a dish. These buttons do not have to be drop and change buttons. They can be increase-and-decrease buttons in other embodiments. The icons used for these two buttons may vary as well. Other buttons are also feasible to serving the same functions;
these dish names are tappable. When one is tapped, a dish description window is pop up;
dish description window depicts a dish with a picture and a text description;
for customers without a reservation, in the Dining Organizer area of the said main menu page, you can enter a dinner by tapping Add Person button, then typing in a name, and optionally an email address and telephone number;
customer taps Add Person button to add more participants;
customer taps Favors & Allergies button while a participant is highlighted, a window with several fields is pop up for typing in these information. How many fields are in the said window is up to specific embodiment;
dish pick page is entered when the NEXT button is tapped while a menu item and a participant are highlighted. In the Dish Pick page, user taps a button to pick a dish of which the button is tied to. User can check each dish by tapping its icon picture or name. When the user taps an icon picture, the said dish description window pops up. The three column dishes displayed of the said dish pick page is only one embodiment. It can be one or two or other numbers of columns of dish display, depends on the screen size of a mobile device. Furthermore, after a dish is picked, the button's color or content, or even the dish's content can be changed: such as when a dish is tapped once, digit 1, and two button of increase + and decrease − are displayed. When increase button + is tapped, the digit 1 becomes 2; likewise, when the decrease button − is tapped, the digit is decreased 1. When it's decreased to zero, the digit is disappeared;
the customer cannot access the said admin page. In order for a staff member to return to the said admin page, he/she taps the A button then the login page is shown. When the login succeeds, the admin page is displayed; if fails, the user is returned to main menu page with a flash message states login fails. In alternative or future embodiments of the invention, a different lock implementation may be used and/or the user may be redirected to different pages;
other screens and/or pages are possible, depended on the specific embodiment, such as, the main menu page can be implemented in two pages: one page only for participant list, and another page only for the activity menu; others can be service provide image pages or advertisements when tablet is idle.

6. The method of claim 1, further comprising, after a participant list and a Menu Tablet:
a loyalty program which comprises of set up sub-process and measure scope sub-process. You need logging in to the system as the owner/staff of a hosting organization, then click on the said loyalty program link, you arrive at loyalty program screen.

7. The method of claim 6, wherein providing the said loyalty program for exposure set up sub-process to the said plurality of client devices comprises:
a field for displaying the said hosting organization's name;
a field for entering a loyalty program name;
a radio button of two choices: three tiers or Segments;
the choices for the said radio button can be more, not have to be limited to two in other embodiments.

8. The method of claim 7, the said three tiers comprising,
three tiers: Gold, Silver, and Reward. Other embodiment can have different number of tiers;
measured by spending amount or visit count or both or either of the two. So there are four predicates: measured by spending amount, measured by visit count, AND, and OR;
a form with three rows to define the three tiers of which each row consists of four entry fields to specify a tier level requirements: lower and upper bound amounts of spending amount and lower and upper bound counts of visit count;
a reward can be configured as percentage of spending as discount, percentage of spending as coupon, or air mile when the said tier level is achieved. Also, the mix of these three rewards is supported.

9. The method of claim 7, the said segments comprising,
segments: can be defined as 5, 6, . . . , up to 10 segments;
a form with same rows as the said number of segments is rendered of which each row comprising,
four entry fields to specify a segment level requirements: lower and upper bound amounts of spending, and lower and upper bound counts of visits;
a reward can be configured as percentage of spending as discount, percentage of spending as coupon, or air mile when the said segment level is achieved. Also the mix of these three rewards is supported.

10. The method of claim 6, wherein providing said loyalty program for exposure measure scope sub-process to said plurality of client devices comprises:
space measure scope, used for determining the extent of customer loyalty, has 10 choices:
Global-Overall/Global-Industry;
Country-Overall/Country-Industry;
State/Province-Overall/State/Province-Industry;
City-Overall/City-Industry;
Chain;
Service provider.
calculated by lifetime, or, it can be calculated annually, with the start of the year on the first of a month;
These loyalty measurements are calculated monthly. The accumulated spending amounts and/or visit counts will be reset if it is configured on an annual base. For a new year of a loyalty program, the system carries on the customer previous year tier/segment level. It lowers a customer's tier/segment level only at the end of a loyalty program year based on his/her entire year's spending amount and/or visit count, called as yearly process. A yearly time span can be defined as starting on the first of a month. So the yearly process is done on which a defined year is completed. It increases a customer's tier/segment level on a monthly process supposing his/her measurement is met the corresponding criterion;
For the lifetime span, no reset will occur. Any spending/visit in the defined space scope is counted, and the loyalty level will not be lowered.

11. The method of claim 1, further comprising, after a participant list, a menu tablet, and a loyalty program:
a community build service which consists of
post comment of user experience;
post service experience;
rate services;
rate customer values;
blog user experience, favors, culture, expertise, recipe;
post request for proposal (RFP) for a planning event;
answer FRP.

12. A server apparatus comprising a processor and a memory, the memory including instructions that when executed by the processor, configure the server apparatus to event organizer applications on client devices of a plurality of mobile-device types and/or laptop types and/or desktop types and/or menu tablet according to a method comprising:
determine the type of client devices and render contents accordingly;
setup of an event with convener's info, event name, location, time and a participant list;
email each participant of the said list with detail information of the event and two links to accept/decline the event;
check the email address to see whether its registered or not when the said accept link is clicked;
register the said email address by prompting the user to enter a password and repeat the prompt if the said email address is not registered;
render service provider's activities for user checks and selects;
store user's preferences, medical alert information, allergies, etc and display these to the proper service provider's staff for attention;
support service menu when request is received from an menu tablet;
store a loyalty program configuration and run monthly and yearly process accordingly if one exists and the result is communicated to users when some criterion set beforehand are met;
provide a community build service.

13. The server apparatus of claim 12, wherein providing said event for exposure to the said plurality of client devices comprises:
storing event detail;
send the event to its service provider for schedule and confirmation;
record responses from the said service provider;
communicate the said responses to users;
register a new user through his/her email address;
maintain the event and user contents current.

14. The server apparatus of claim 12, the said convener's info, comprising, customer account id/screen name, email address and telephone number. All three are required for confirmation and contact for contingency.

15. A non-transitory computer-readable storage medium storing instructions that when executed by a processor, configure the processor to provide menu functions on a tablet according to a method comprising:
boot screen which includes a login page and an administration page. The login page can be configured as a pattern lock or PIN or password, as the standard of a mobile device. When a customer arrives and has a reservation, the said service provider's staff will find the reservation with which resources are allocated. For a customer without a reservation, the user taps the “NO Reservation” button and it brings the user to the Get Table page after providing a name and a number of persons;
admin page comprising of service provider's name, current date and time, day buttons and service type buttons, and a reservation list plus three button: Table, NO Reservation and NEXT. Optionally providing some search aids for finding a reservation;
get table page mainly comprises of two parts: a room list and table list of the highlighted room. When a table cannot be tapped, this is an indicator that it is occupied/allocated. For an occupied table, there are three numbers and a time, listed as follows: the table no., table capacity and the number of diners booked, showing how many persons can be seated at the table and will be seated, and the time occupied or reserved. Usually the number of diners is equal to or fewer than the table capacity, but sometime the number of diners can be greater than the table capacity, due to chairs can be added to a table. For those tables not occupied, only the first two are shown as table no. and table capacity, and rendered as a button;
As Table button is tapped while a reservation is highlighted, a user gets to the said get table page and can change tables for the reservation by tapping a table button to select/unselect it for the said reservation. When an unallocated table button is tapped, it becomes allocated after a number of persons and a time are provided. Also, it displays the service provider's name and current date and time plus the name and participant number of the reservation on the top of the page;
after highlighting a day, a service type, and a reservation, the user taps the NEXT button of the said admin page, the user is then redirected to the main menu page of the said menu tablet;
main menu page comprises of two components: dishes/activities menu and participant list. Customer taps a participant name, which will expand if the person has picked dishes/drinks. The user can edit those already picked dishes by tapping the two buttons: the change button, to change the number of dishes; and the drop button, to remove a dish. These buttons do not have to be drop and change buttons. They can be increase and decrease buttons in other embodiments. And the icons used for these two buttons may vary too. Other buttons are also feasible to serving the same functions;
these dish names are tappable. When one is tapped, a dish description window is popped up;
dish description window represents a dish with a picture and a text description;
for customers without a reservation, in the Dining Organizer area of the said main menu page, you can enter a dinner by tapping Add Person button, then typing in a name, and optionally an email address and telephone number;
the customer taps the Add Person button to add more dinners;
the customer taps Favors & Allergies button while a diner is highlighted, a window with several text fields is pop up for typing in these information. How many fields are in the said window is up to the specific embodiment;
dish pick page is entered when the NEXT button is tapped while a menu item and a diner are highlighted. In this Dish Pick page, user taps a button to select a dish of which the button is tied to. User can check each dish by tapping its icon picture or name. When the user taps an icon picture, the said dish description window pops up. The three column dishes displayed of the said dish pick page is only one embodiment. It can be one or two or other numbers of columns of dish display, depends on the screen size of a mobile device. Furthermore, after a dish is selected, the button's color or content, or even the dish's content can be changed: such as when a dish is tapped once, digit 1, and two button of increase + and decrease − are displayed. When increase button + is tapped, the digit 1 becomes 2; likewise, when the decrease button − is tapped, the digit is decreased 1. When it's decreased to zero, the digit is disappeared;
customer cannot access the said admin page. In order for a staff member to return to the said admin page, he/she taps the A button then a login page is shown. When the login succeeds, the admin page is displayed; if fails, the user is returned to main menu page with a flash message states login fails. In alternative or future embodiments of the invention, a different lock implementation may be used and/or the user may be redirected to different screens;
other screens and/or pages are possible, depended on a specific embodiment, such as, the main menu page can be implemented in two pages: one page only for participant list, and another page only for the activity menu; others can be service provide image pages or advertisements when tablet is idle.

16. The menu tablet of claim 15, a graphical user interface on client devices of a plurality of mobile-device types with a touch screen display, comprising:
boot screen which includes a login page and an administration, page. The login page can be configured as a pattern lock or PIN or password, as the standard of a mobile device. When a customer arrives and has a reservation, the said service provider's staff will find the reservation with which resources are allocated. For a customer without a reservation, the user taps the “NO Reservation” button and it brings the user to the Get Table page after providing a name and number of persons;
admin page comprising of service provider's name, current date and time, day buttons and service type buttons, and a reservation list plus three button: Table, NO Reservation and NEXT. Optionally provide some search aids for finding a reservation;
get table page mainly comprises of two parts: a room list and a table list of the highlighted room. When a table cannot be tapped, this is an indicator that it is occupied or allocated. For an occupied table, there are three numbers and a time, listed as follows: the table no., table capacity and the number of diners booked, showing how many persons can be seated at the table and will be seated, and the time occupied or reserved. Usually the number of diners is equal to or fewer than the table capacity, but sometime the number of diners can be greater than the table capacity, due to chairs can be added to a table. For those tables not occupied, only the first two are shown as table no. and table capacity, and rendered as a button;
when Table button is tapped while a reservation is highlighted, a user gets to the said get table page and can change tables for the reservation by tapping a table button to select/unselect it for the said reservation. When an unallocated table button is tapped, it becomes allocated after a number of persons and a time are provided. Also, it displays the service provider's name and current date and time plus the name and participant number of the reservation on the top of the page;
after highlighting a day, a service type, and a reservation, the user taps the NEXT button of the said admin page, the user is then got to the main menu page of the said menu tablet;
main menu page comprises of two components: dishes/activities menu and participant list. Customer taps a participant name, which will expand if the person has picked dishes/drinks. The user can edit those already picked dishes by tapping the two buttons: the change button, to change the number of dishes; and the drop button, to remove a dish. These buttons do not have to be drop and change buttons. They can be increase and decrease buttons in other embodiments. And the icons used for these two buttons may vary too. Other buttons may be utilized in other embodiments;
these dish names are tappable. When one is tapped, a dish description window is popped up;
dish description window represents a dish with a picture and a text description;
for customers without a reservation, in the Dining Organizer area of the said main menu page, you can enter a dinner by tapping Add Person button, then typing in a name, and optionally an email address and a telephone number;
customer taps Add Person button to add more dinners;
customer taps Favors & Allergies button while a diner is highlighted, a window with several text fields is pop up for inputting these information. How many fields are in the said window is up to a specific embodiment;
dish pick page is entered when the NEXT button is tapped while a menu item and a diner are highlighted. In this Dish Pick page, user taps a button to select a dish of which the button is tied to. User can check each dish by tapping its icon picture or name. When user taps an icon picture, the said dish description window pops up. The three column dishes displayed of the said dish pick page is only one embodiment. It can be one or two or other numbers of columns of dish display, depends on the screen size of a mobile device. Furthermore, after a dish is selected, the button's color or content, or even the dish itself content can be changed: such as when a dish is tapped once, digit 1, and two buttons of increase + and decrease − are displayed. When increase button + is tapped, the digit 1 becomes 2; likewise, when the decrease button − is tapped, the digit is decreased 1. When it's decreased to zero, the digit is disappeared;
The customer cannot access the said admin page. In order for a staff member to return to the said admin page, he/she taps the A button then a login page is shown. When the login succeeds, the admin page is displayed; if fails, the user is returned to main menu page with a flash message states login fails. In alternative or future embodiments of the invention, a different lock implementation may be used and/or the user may be redirected to different screens;
other screens and/or pages are possible, depended on a specific embodiment, such as, the main menu page can be implemented in two pages: one page only for participant list, and another page only for the activity menu; others can be service provide image pages or advertisements when tablet is idle.

17. The method of claim 1 or the server apparatus of claim 12, wherein providing the said event for exposure to the said plurality of the mobile client devices comprises:
a button to mark the event on the calendar of the mobile device if a calendar application is installed.
